(19) United States
(12) Patent Application Publication
(10) Pub. No.: US 2006/0271534 A1
(43) Pub. Date: Nov. 30, 2006

(54) Information-providing apparatus and information-providing method

(75) Inventors: Yoshitaka Hamaguchi, Nara (JP); Shin Torigoe, Osaka (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/438,351

(22) Filed: May 23, 2006

(30) Foreign Application Priority Data
May 25, 2005 (JP) 2005-152734

(51) Int. Cl. G06F 17/30

(52) U.S. Cl. 707/5

(57) ABSTRACT

According to the present invention, among related information candidates that may be provided as related information, candidates with high similarity factors indicating high extents of similarity to delivery information delivered to a subject user are disqualified. In addition, related information candidates originating from the same information source as that of the delivery information having been obtained for the subject user or originating from a well-known information source are disqualified. Also, any portion of a related information candidate that remains unchanged in different versions of the candidate information is disqualified. Then, the related information to be provided to the user is selected from the qualified related information candidates.

### CROSS REFERENCE TO RELATED APPLICATIONS

The disclosure of Japanese Patent Application No. JP 2005-152734 filed on May 25, 2005 is incorporated herein by reference in its entirety.

### BACKGROUND OF THE INVENTION

1. Field of the Invention

The present invention relates to an information-providing apparatus and an information-providing method, which may be adopted in services for providing users with information.

2. Description of the Related Art

Information to be delivered to a user is compiled in the related art by grouping similar types of information extracted from other delivered information, information delivered in the past and information delivered to other parties together with information matching user-specified conditions.

Through such a system, the user, provided with similar types of information, is able to check the related information in a batch. In addition, the user is able to review the past transactions at once, and is also able to learn how other users use similar information.

The similar types of information grouped together as described above can be handled in a batch for more convenience.

Under normal circumstances, when a user requests a delivery of information such as Web content or an e-mail magazine, he can expect to find a specific type of information he needs in the delivered information.

However, the user may not be aware that there is another information source that provides the type of information he is looking for. If the user is not even aware of the existence of such an information source, he cannot find it through a search.

The user, presented with additional information similar to the information delivered to him in response to his request, becomes a more expert user, better equipped to take advantage of information and information sources, the existence of which has not even been aware of.

In addition, information selected by another user for delivery may be worth including in the information to be delivered to the user or its source may be worth introducing to the user.

Namely, similar information may be extracted from the information delivered to the other user and provided to the subject user.

Information may be made available as described above by adopting the method in the related art by providing the subject user with information similar to the information delivered in response to the user request, which has been delivered to another user. However, the object of the method in the related art is to enable uniform handling of pieces of information similar to one another, and thus, additional information provided to the user is often not much different from the information delivered to the user in response to his request.

Similar types of information are likely to originate from a site that provides a plurality of types of information, such as a news site. In other words, such a site is often the source of the additional similar information. However, the subject user is highly likely to be aware of such a well-known information source and is also highly likely to already have access to the information source. Under these circumstances, introducing the information source to the user will be superfluous.

Furthermore, the additional information, similar to the information delivered to the user in response to his request, may be set up so as to be continuously and repeatedly delivered to users. For instance, campaign information may be repeatedly and continuously delivered during the campaign period, subjecting the user to a strain of repetitive and redundant information.

As explained above, if similar types of information are simply provided as additional information, the user is likely to receive a plurality of sets of information he already has, and information the user does not yet have, which he is likely to find interesting, will be placed low in the priority order. Such information that will actually interest the user may never be provided to the user or may be buried so deeply in the results that the user will never find it.

Accordingly, an information-providing apparatus and an information-providing method, that make it possible to provide the user with information he does not yet have, which is likely to interest him.

### SUMMARY OF THE INVENTION

In a first aspect of the present invention, the object described above is achieved by providing an information-providing apparatus that obtains information to be delivered to a user from an information source as delivery information and delivers the delivery information to the user based upon a setting selected by the user and also provides related information related to the delivery information, characterized in that the information-providing apparatus includes an overlapping information averting means for selecting the related information by disqualifying a related information candidate that would overlap the delivery information or would be likely to overlap the delivery information among related information candidates being considered to be used as the related information.

The object described above is achieved in a second aspect of the present invention by providing an information-providing method for obtaining information to be delivered to a user as delivery information from an information source delivering the delivery information to the user based upon a setting selected by the user and also providing related information related to the delivery information, which includes an overlapping information averting step in which the related information is selected by disqualifying a related information candidate that would overlap the delivery information or would be likely to overlap the delivery information among related information candidates being considered for use as the related information.

In addition, it is possible to provide an information-providing program written in a code that enables a computer to implement the information-providing method achieved in the second aspect of the present invention.

According to the present invention, related information that is not identical to the delivery information delivered to the user has not been available to the user yet and is likely to interest the user can be provided to the user.

### BRIEF DESCRIPTION OF THE DRAWINGS

FIG. 1 is a block diagram showing the functional structure of the information-providing apparatus achieved in a first embodiment;

FIG. 2 presents examples of information, to be referred to in an explanation of the operation executed in the information-providing apparatus achieved in the first embodiment;

FIG. 3 is a block diagram showing the functional structure of the information-providing apparatus achieved in a second embodiment;

FIG. 4 presents examples of information, to be referred to in an explanation of the operation executed in the information-providing apparatus achieved in the second embodiment;

FIG. 5 is a block diagram showing the functional structure of the information-providing apparatus achieved in a third embodiment;

FIG. 6 presents examples of information, to be referred to in an explanation of the operation executed in the information-providing apparatus achieved in the third embodiment;

FIG. 7 is a block diagram showing the functional structure of the information-providing apparatus achieved in a fourth embodiment; and

FIG. 8 presents examples of information, to be referred to in an explanation of the operation executed in the information-providing apparatus achieved in the fourth embodiment.

### DETAILED DESCRIPTION OF THE PREFERRED EMBODIMENTS

### (A) First Embodiment

The following is a detailed explanation of the information-providing apparatus and the information-providing method achieved in the first embodiment of the present invention, given in reference to drawings.

### (A-1) Structure of the First Embodiment

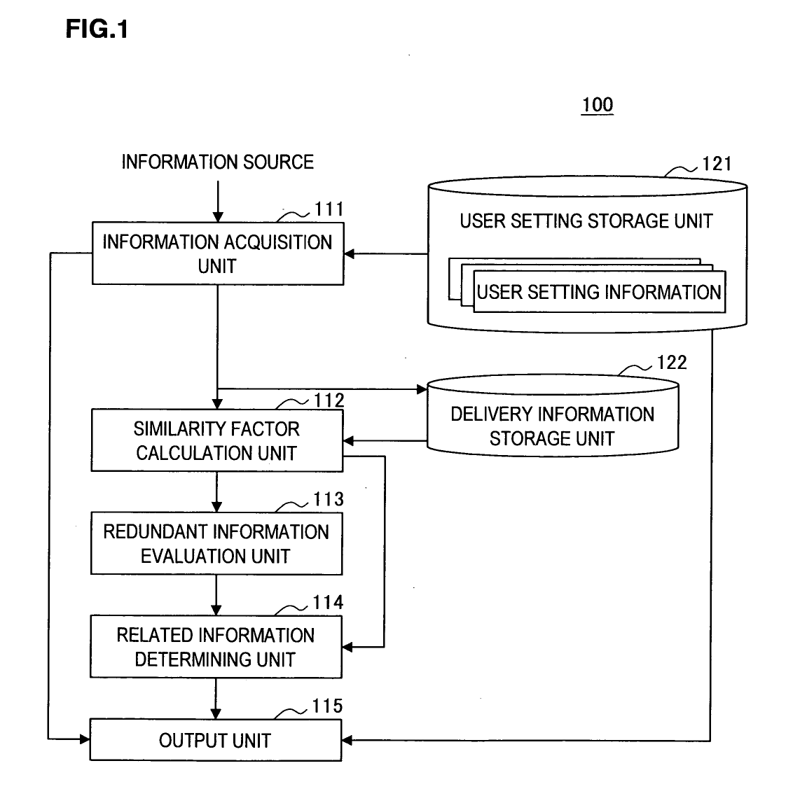

The information-providing apparatus in the first embodiment is constituted by installing an information-providing program in an information processing apparatus with a communication function, such as a server or a personal computer and adopts a functional structure such as that shown in FIG. 1. It is to be noted that the information-providing program may be installed from a recording medium or downloaded from another apparatus, or it may be entered via a keyboard or the like.

The information-providing apparatus 100 achieved in the first embodiment shown in FIG. 1 comprises an information acquisition unit 111, a similarity factor calculation unit 112, a redundant information evaluation unit 113, a related information-determining unit 114, an output unit 115, a user setting storage unit 121 and a delivery information storage unit 122.

In the user setting storage unit 121, information indicating settings needed when delivering information to a specific user is stored in correspondence to a single user or a plurality of users. At the user setting storage unit 121, an information source from which information is to be obtained, for instance, may be set in correspondence to each user. Such an information source may be an apparatus connected via a communication network or it may be a database or the like created in the same hardware constituting the information-providing apparatus. In addition, if the user wishes to receive specific information originating from a given information source, search conditions and the like entered through a user setting operation, too, are stored (in such a case, there may or may not be preset information on source information). If the information is to be delivered to the user via e-mail, information indicating the output recipient, e.g., an e-mail address, is also stored.

Such settings may be entered at the user setting storage unit 121 through any method. For instance, they may be entered via an input means such as a keyboard by the system manager based upon the content of an agreement reached by the system manager and the user, or they may be entered by the user on a settings page on the web site provided by the information-providing apparatus by using a browser function or the like of the user's personal computer.

The information acquisition unit 111, which has a communication function, obtains delivery information to be delivered matching a search condition setting (hereafter referred to as primary information) from the information source having been set for each of the users in correspondence to whom the user setting information is stored at the user setting storage unit 121, stores the delivery information thus obtained into the delivery information storage unit 122 and delivers the information to the specific user via the output unit 115 to be detailed later.

The delivery information may be obtained from the information source by issuing a request via the information acquisition unit 111 or information automatically transmitted from the information source may be selectively obtained based upon a user setting. In addition, the information acquisition unit 111 may obtain the delivery information by executing cyclical time processing, or an information acquisition time point may be set in correspondence to the information source as indicated in the user setting information and execute an operation for obtaining the information at this point in time.

At the delivery information storage unit 122, the primary information having been previously output by the information acquisition unit 111 within a predetermined length of time is stored as storage information. The predetermined length of time may be a fixed length of time, e.g., over the past month, or it may be a relative length of time, e.g., the three most recent versions of information.

At the delivery information storage unit 122, a given set of primary information may be stored individually in correspondence to each of different users having been provided with the information, or such primary information may be stored only once by appending information that enables identification of all the users related to the particular information. In other words, any method may be adopted for primary information storage as long as the functions of the similarity factor calculation unit 112 are not compromised. It is to be noted that information may be stored at the delivery information storage unit 122 without attaching any user identification information.

The similarity factor calculation unit 112 calculates the similarity factor for each set of storage information stored at the delivery information storage unit 122, indicating the extent of similarity to specific primary information obtained at the information acquisition unit 111, in correspondence to each user. The similarity factor calculation unit 112 may first calculate the similarity factor for each two sets of storage information stored at the delivery information storage unit 122 and then may individually calculate the similarity factor in relation to the primary information corresponding to each user. Alternatively, it may individually calculate the similarity factor indicating the similarity between the primary information and each set of storage information corresponding to the user. The latter method may be adopted when a specific transmission time point at which information (primary information and related information to be detailed later) is to be transmitted is set in advance in correspondence to each user. The similarity factor calculation unit 112 may be achieved by adopting any of similar document search methods practiced widely, e.g., by calculating a tf·idf evaluation value after each set of information (each document) undergoes morphological analysis.

The redundant information evaluation unit 113 makes a decision for each user as to whether or not a particular set of storage information is suitable to be provided to the subject user based upon the similarity factor having been calculated in correspondence to the storage information by the similarity factor calculation unit 112. Information that is identical or similar to the primary information obtained by the information acquisition unit 111 as delivery information for the user is redundant and should not be provided to the user. Accordingly, the redundant information evaluation unit 113 achieved in the first embodiment determines that storage information with a high similarity factor is more likely to be redundant based upon a specific rule. This evaluation may be executed by using an evaluation value calculated as indicated in a specific arithmetic expression based upon the similarity factor or by using a binary value indicating whether or not the particular storage information is to be provided.

The following explanation is given by assuming that the redundant information evaluation unit 113 uses a threshold value achieving a specific ratio (e.g., 75%) to the similarity factor of the storage information that is not exactly identical to the delivery information (primary information) obtained for the specific user but still has the highest similarity factor, and that the redundant information evaluation unit 113 determines that any storage information with a similarity factor equal to or greater than the threshold value is redundant. The specific ratio mentioned above may be adjusted by the user.

The related information determining unit 114 selects related information to be provided to the specific user in relation to the delivery information (primary information) obtained for the user, from various sets of storage information based upon the evaluation values provided by the redundant information evaluation unit 113 and the similarity factors having been calculated by the similarity factor calculation unit 112. For instance, a predetermined number (may be adjusted by the user) of sets of storage information that have not been judged to be redundant and have the highest similarity factors may be selected as related information. Alternatively, related information may be selected by setting a specific lower limit parameter (e.g., a similarity factor lower limit) instead of the predetermined number of sets of related information.

The output unit 115 outputs the primary information obtained by the information acquisition unit 111 and the related information obtained via the related information determining unit 114 so as to allow the specific user to view the information by adopting a specific method, e.g., by transmitting the information to the e-mail address stored in correspondence to the user at the user setting storage unit 121. It is to be noted that the output unit 115 may deliver or transmit the information in response to a retrieve operation executed at the user-side apparatus instead of voluntarily delivering or transmitting the information.

### (A-2) Operation executed in the First Embodiment

Next, the operation executed by the information-providing apparatus 100 in the first embodiment (the information-providing method achieved in the first embodiment) is explained in reference to a specific example. It is to be noted that FIG. 1, in reference to which the first embodiment is described above, may be regarded as a flowchart of the operation executed by the information-providing apparatus 100 in the first embodiment.

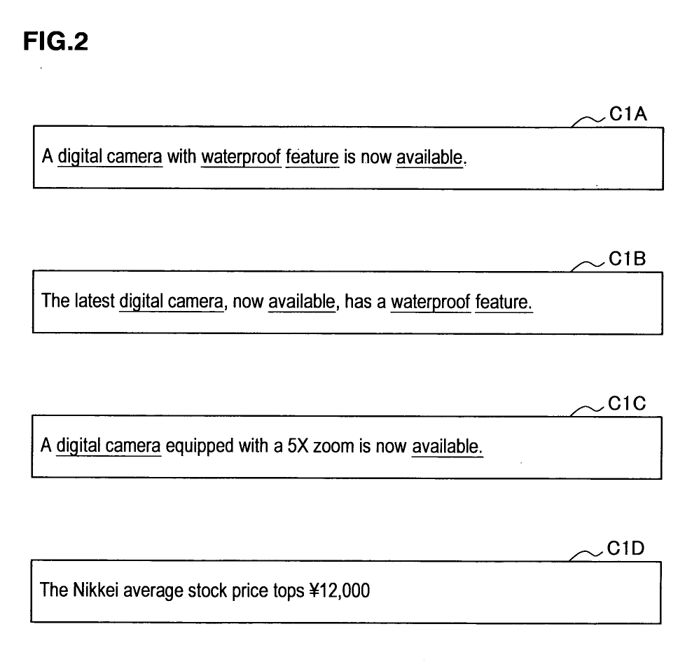

The information acquisition unit 111 obtains information satisfying specific conditions from an information source set in correspondence to each user at the user setting storage unit 121 and stores the obtained information at the delivery information storage unit 122. Let us now assume that delivery information (primary information) C1A in FIG. 2 is obtained for a given user 1A, that information (primary information) C1B, information (primary information) C1C and information (primary information) C1D in FIG. 2 are obtained for other users 1B, 1C and 1D respectively and that these sets of information C1A through C1D are stored at the delivery information storage unit 122.

In correspondence to the user 1A, the similarity factor calculation unit 112 individually calculates similarity factors indicating the extents of similarity of the delivery information C1A in FIG. 2 to the other sets of storage information C1B through C1D in FIG. 2 in the delivery information storage unit 122.

From the delivery information C1A in FIG. 2, words such as “digital camera”, “waterproof”, “feature” and “available” can be extracted as keywords through a standard natural language processing technology such as morphological analysis.

The similarity factor calculation unit 112 calculates the similarity factor to be, for instance, 4/4=100% for the delivery information C1A and the storage information C1B in FIG. 2, which contains all four keywords. While the similarity factor is calculated as the ratio of the number of keywords contained in the target storage information to simplify the explanation, the similarity factor may be calculated using a standard document search evaluation method by, for instance, adjusting the weight of each keyword through the idf adjustment. The similarity factor calculation unit 112 calculates the similarity factor for the storage information C1C in FIG. 2 containing two keywords, “digital camera” and “available”, to be 2/4=50% and calculates the similarity factor for the storage information C1D in FIG. 2 containing no matching keywords to be 0%.

The redundant information evaluation unit 113 designates a specific ratio (e.g., 75%) to the evaluation value 100% having been calculated for the storage information C1B in FIG. 2 with the highest similarity factor, as the threshold value and makes a decision as to whether or not the individual sets of information are redundant information that does not need to be provided to the user 1A. The storage information C1B with the similarity factor at 100% is judged to be redundant, the storage information C1C with the similarity factor at 50% is not judged to be redundant and the storage information C1D with the similarity factor at 0% is not judged to be redundant.

The related information-determining unit 114 selects related information to be delivered together with the primary information C1A to the user 1A from the sets of storage information C1B through C1D excluding the primary information C1A having been obtained for the user 1A. Let us assume that the number of sets of related information to be selected by the related information-determining unit 114 has been set at 1. The related information-determining unit 114 does not select the storage information C1B as the related information since it has been judged by the redundant information evaluation unit 113 to be redundant. While either the storage information C1C or the storage information C1D has not been judged to be redundant by the redundant information evaluation unit 113, the number of sets of related information to be selected is 1 and, accordingly, the related information determining unit 114 selects the storage information C1C with a higher similarity factor, i.e., 50%, as the related information to be provided to the user 1A.

Through the processing described above, the user 1A receives the information C1C in FIG. 2 as the related information as well as the primary information C1A in FIG. 2 from the output unit 115. It is to be noted that the primary information and the related information may be presented in a uniform manner or the related information may be presented by adopting a mode different from the mode with which the primary information is presented. For instance, an icon indicating that there is related information may be displayed over part of the primary information screen and the related information may be brought up on display as the icon is clicked. Alternatively, the delivery of the related information itself may be executed in response to a click.

As described above, the user 1A receives the related information C1C in FIG. 2 together with the delivery information C1A in FIG. 2, but the information C1B in FIG. 2 with the higher similarity factor and substantially identical content to the content of the delivery information C1A in FIG. 2 is not provided to the user 1A. In other words, the user 1A does not receive sets of similar information with overlapping content.

### (A-3) Advantages of the First Embodiment

In the first embodiment, information that the user does not yet have and is likely to interest the user is provided as related information.

At the same time, information with a high similarity factor in relation to the delivery information obtained for the user, i.e., information with content that the user is likely to have already obtained from the delivery information or the user is likely to be able to obtain based upon the delivery information is not provided as related information. As a result, the user is not inundated with many sets of information with similar content, which assures better convenience for the user.

### (B) Second Embodiment

The following is a detailed explanation of the information-providing apparatus and the information-providing method achieved in the second embodiment of the present invention, given in reference to drawings.

### (B-1) Structure of the Second Embodiment

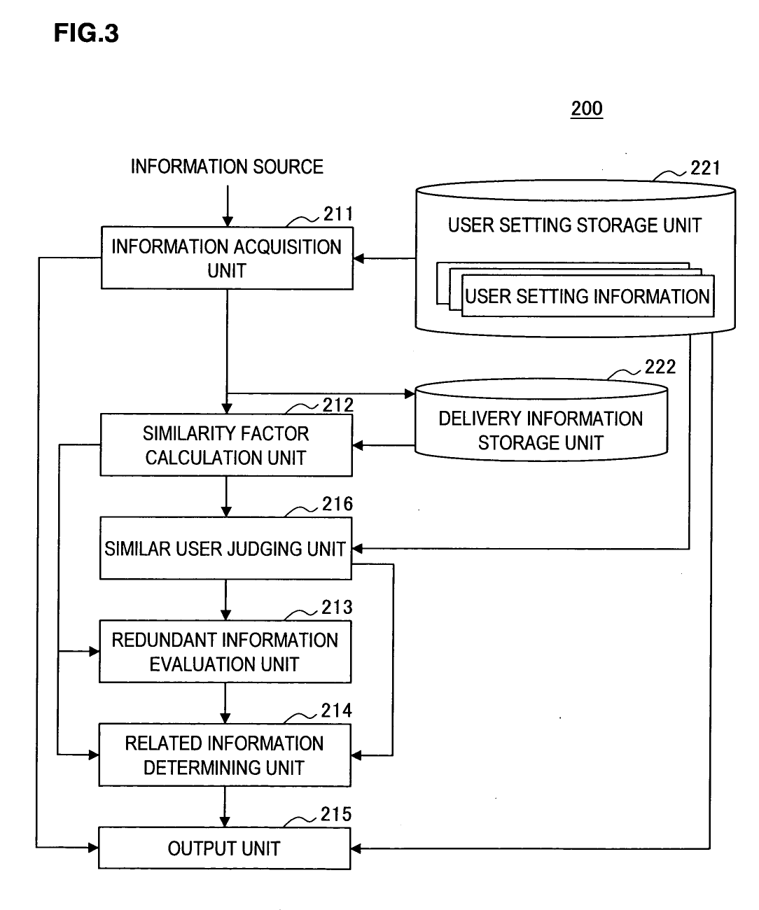

The information-providing apparatus in the second embodiment, too, is constituted by installing an information-providing program in an information processing apparatus with a communication function, such as a server or a personal computer and adopts a functional structure such as that shown in FIG. 3. It is to be noted that in FIG. 3, corresponding reference numerals (with the numeral in the hundred place changed from “1” to “2”) are assigned to components identical to or corresponding to those in FIG. 1 in reference to which the first embodiment has been explained.

The information-providing apparatus 200 achieved in the second embodiment shown in FIG. 3 comprises an information acquisition unit 211, a similarity factor calculation unit 212, a redundant information evaluation unit 213, a related information determining unit 214, an output unit 215, a user setting storage unit 221 and a delivery information storage unit 222, as does the apparatus achieved in the first embodiment. The information-providing apparatus 200 further includes a similar user-judging unit 216.

The information acquisition unit 211, the similarity factor calculation unit 212, the output unit 215 and the user setting storage unit 221 are similar to those in the first embodiment.

While the delivery information storage unit 222 is similar to the delivery information storage unit 122 in the first embodiment, it is essential in the second embodiment that each set of storage information be stored with a clear indication of the specific user setting information corresponding to a given user based upon which the storage information has been obtained.

The similar user-judging unit 216 obtains user information (user) IDs of the users other than the processing target user, which are appended in correspondence to many sets of storage information with high similarity factors having been calculated for the subject user by the similarity factor calculation unit 212. In other words, it detects another user or a plurality of other users having obtained significant numbers of sets of similar delivery information, as a similar user or similar users. For instance, in correspondence to each of the other users, the sum of the similarity factors having been calculated for the storage information corresponding to his user ID is calculated as his user score and if the user has a high score, he is judged to be a similar user. A fixed number (which may be adjusted by the user) may be determined as similar users, or all the other users with scores equal to or greater than a predetermined value (which may be adjusted by the user) may be judged to be similar users.

Since the object of this processing is to determine similar users, it may instead be executed by simply comparing individual sets of the user setting information and determining a user with similar search conditions, e.g., similar information sources and similar keywords, to be a similar user. Alternatively, similar users may be determined, each based upon user attribute data such as the user age, profession and gender indicated in the user agreement data. Furthermore, the different methods for determining similar users may be adopted together in combination.

The redundant information evaluation unit 213 achieved in the second embodiment evaluates each set of storage information corresponding to a similar user ascertained by the similar user judging unit 216 to make a decision as to whether or not the storage information is suitable to be provided to the subject user based upon the similarity factor having been calculated for the storage information by the similarity factor calculation unit 212. The redundant information evaluation unit 213 in the second embodiment is identical to the redundant information evaluation unit 113 in the first embodiment, except that the target of the redundancy decision-making is limited to the storage information stored in correspondence to similar users.

The related information determining unit 214 in the second embodiment selects the related information to be provided to the subject user together with the delivery information from the storage information corresponding to the similar users having been ascertained by the similar user judging unit 216 based upon evaluation values calculated by the redundant information evaluation unit 213 and similarity factors calculated by the similarity factor calculation unit 212. For instance, among the sets of storage information corresponding to similar users, which have not been judged to be redundant, a predetermined number of sets of storage information with the highest similarity factors are selected as the related information. The number of sets of related information to be selected may be freely set in the system or may be specified by the user, as in the first embodiment.

### (B-2) Operation Executed in the Second Embodiment

Next, the operation executed by the information-providing apparatus 200 in the second embodiment (the information-providing method achieved in the second embodiment) is explained in reference to a specific example. It is to be noted that FIG. 3, in reference to which the second embodiment is described above, may be regarded as a flowchart of the operation executed by the information-providing apparatus 200 in the second embodiment.

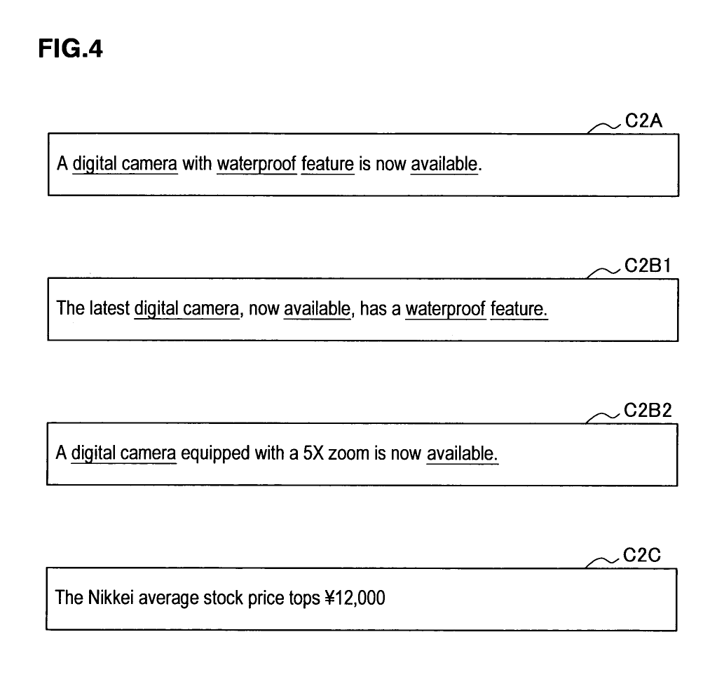

The information acquisition unit 211 obtains information satisfying specific conditions from an information source set in correspondence to each user at the user setting storage unit 221 and stores the obtained information at the delivery information storage unit 222. Let us assume now that delivery information (primary information) C2A in FIG. 4 is obtained for a given user 2A, that sets of information C2B1 and C2B2 in FIG. 4 are obtained for another user 2B, that a set of delivery information C2C in FIG. 4 is obtained for another user 2C, and that these sets of information C2A, C2B1, C2B2 and C2C are stored at the delivery information storage unit 222.

For the user 2A, the similarity factor calculation unit 212 calculates similarity factors indicating the extents of similarity of the delivery information C2A in FIG. 4 to the sets of storage information C2B1, C2B2 and C2C in FIG. 4 stored at the delivery information storage unit 222 in correspondence to the other users 2B and 2C. While a detailed explanation is omitted, it is assumed that the similarity factor for the delivery information C2A and the delivery information C2B1 is calculated to be 100%, that the similarity factor of the delivery information C2A and the delivery to information C2B2 is calculated to be 50% and that the similarity factor of the delivery information C2A and the delivery information C2C is calculated to be 0% (refer to the first embodiment).

At the similarity user judging unit 216, evaluation values are first calculated for the users other than the user 2A, i.e., the users 2B and 2C. The similarity factors of the storage information C2B1 and C2B2 in FIG. 4 corresponding to the user 2B are respectively 100% and 50%, and there is no other storage information corresponding to the user 2B. Accordingly, the evaluation value for the user 2B is calculated as the sum of the similarity factors, i.e., 150. In addition, the similarity factor of the storage information C2C in FIG. 4 corresponding to the user 2C is 0% and there is no other storage information related to the user 2C. Accordingly, the evaluation value for the user 2C is calculated to be 0.

If 1 has been set in advance as the number of users judged to be similar, the user 2B with the higher evaluation value is judged to be a similar user to the user 2A.

The redundant information evaluation unit 213 designates a value(e.g., 75%) representing a specific ratio (75%) to the highest similarity factor 100% having been calculated for the storage information C2B1 among the sets of storage information C2B1 and C2B2 in FIG. 4 corresponding to the user 2B having been judged to be the similar user, and makes a decision as to whether or not a given set of storage information is redundant and does not need to be provided to the subject user 2A. In the example presented in FIG. 4, the storage information C2B1 with its similarity factor at 100% is judged to be redundant but the storage information C2B2 with a similarity factor of 50% is not judged to be redundant.

The related information determining unit 214 selects related information to be delivered together with the primary information C2A to the user 2A from the sets of storage information C2B1, C2B2 and C2C excluding the primary information C2A having been obtained for the user 2A. Let us assume that the number of sets of related information to be selected by the related information determining unit 214 has been set at 1. The related information-determining unit 214 does not select the storage information C2B1 as the related information since it has been judged by the redundant information evaluation unit 213 to be redundant. The storage information C2B2, on the other hand, which has not been judged to be redundant by the redundant information evaluation unit 213 and has a significant similarity factor of 50%, is selected as the related information.

The user 2A receives the storage information C2B2 in FIG. 4 as related information together with the delivery information C2A in FIG. 4 from the output unit 215.

As described above, the user 2A receives as related information the delivery information C2B1 or C2B2 having been obtained for the similar user 2B, with content not identical to the content of the delivery information C2A obtained for the user 2A, together with the delivery information C2A in FIG. 4. At the same time, the delivery information C2B1 or C2B2 for the similar user 2B, which include substantially identical content to the delivery information C2A intended for the user 2A, is not provided to the user 2A.

### (B-3) Advantages of the Second Embodiment

In the second embodiment, the subject user is provided with related information with content not exactly identical to the content of the delivery information having been obtained specifically to be delivered to the target user, selected from sets of delivery information having been obtained for a similar user sharing a common interest with the target user.

Namely, information other than the delivery information selected in correspondence to the user setting is provided to the subject user while ensuring that the user is not presented with redundant information.

### (C) Third Embodiment

The following is a detailed explanation of the information-providing apparatus and the information-providing method achieved in the third embodiment of the present invention, given in reference to drawings.

### (C-1) Structure of the Third Embodiment

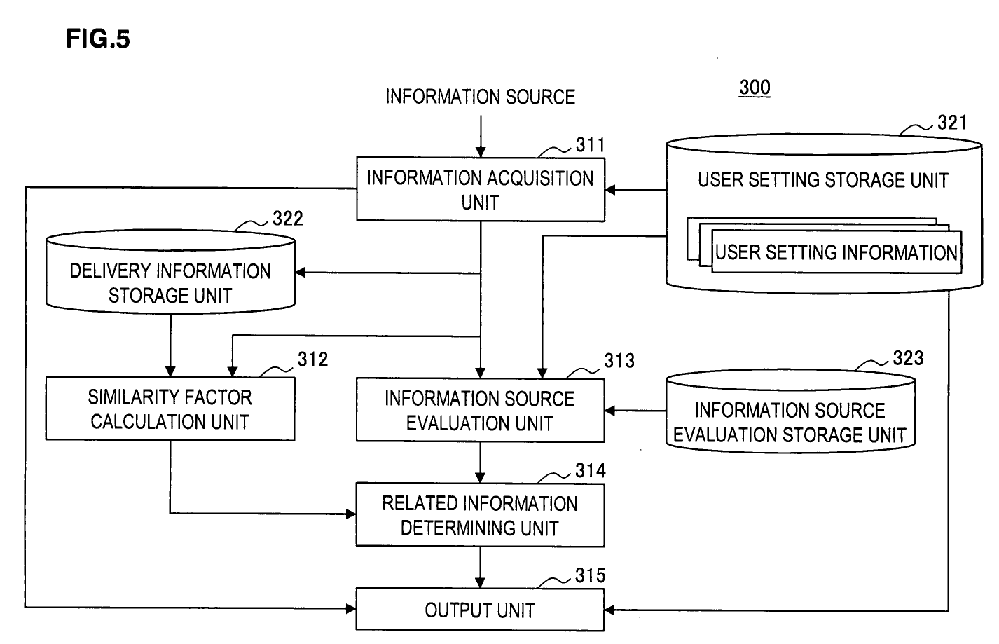

The information-providing apparatus in the third embodiment, too, is constituted by installing an information-providing program in an information processing apparatus with a communication function, such as a server or a personal computer, and adopts a functional structure such as that shown in FIG. 5. It is to be noted that in FIG. 5, corresponding reference numerals (with the numeral in the hundred place changed from “1” to “3”) are assigned to components identical to or corresponding to those in FIG. 1 in reference to which the first embodiment has been explained.

The information-providing apparatus 300 achieved in the third embodiment shown in FIG. 5 comprises an information acquisition unit 311, a similarity factor calculation unit 312, a related information determining unit 314, an output unit 315, a user setting storage unit 321 and a delivery information storage unit 322, as does the information providing apparatus achieved in the first embodiment. The information-providing apparatus 300 further includes an information source evaluation unit 313 and an information source evaluation storage unit 323. It is to be noted that while the third embodiment does not include the redundant information evaluation unit (113), it is equipped with the information source evaluation unit 313 instead.

The information acquisition unit 311, the similarity factor calculation unit 312, the output unit 315 and the user setting storage unit 321 are similar to those in the first embodiment. While the delivery information storage unit 322 is similar to that in the first embodiment, it is the essential in the third embodiment that each set of storage information be stored with a clear indication of the information source.

The information source evaluation unit 313 evaluates a given information source to determine the level of its propriety as an information source from which related information to be provided to each user may be obtained.

For instance, a given user receiving delivery information obtained from a specific information source is likely to have an opportunity to read another set of information originating from the same information source. Accordingly, a low evaluation value is set for the information source from which the delivery information for the user has been obtained or for an information source stored in the user setting information. In addition, the user is likely to already be familiar with a well-known information source such as a news site. Accordingly, such sites (popular information sources) are stored in advance together with corresponding evaluation values at the information source evaluation storage unit 323 so as to retrieve the evaluation value of any of these information sources from the information source evaluation storage unit 323. Moreover, an information source set by multiple users can be considered to be a popular information source that is likely to be known to users in general and thus does not need to be introduced to them. Accordingly, the evaluation value for an information source selected by a greater number of users should be calculated so as to designate a lower evaluation value to such an information source based upon the number or the ratio of users setting the information source as their delivery source by referencing the information stored at the user setting storage unit 321.

The information source evaluation unit 313 synthesizes the evaluation value through a standard evaluation value synthesizing method, e.g., through multiplication, selection of the least value among the products or the like.

In correspondence to each user, the related information determining unit 314 in the third embodiment selects storage information having a high similarity factor, calculated by the similarity factor calculation unit 312, and originating from an information source with a high evaluation value, designated thereto by the information source evaluation unit 313, as related information to be provided to the user. The selection of the related information based upon the similarity factor of the storage information and the evaluation value of the information source may be executed by adopting a standard method in which two different types of parameters are used. For instance, the related information may be selected based upon the value obtained by multiplying the similarity factor by the evaluation value. In addition, certain restrictions may be imposed if the evaluation value is equal to or less than a predetermined value, e.g., no storage information originating from the information source is selected as related information if the evaluation value is equal to or less than the predetermined value.

### (C-2) Operation Executed in the Third Embodiment

Next, the operation executed by the information-providing apparatus 300 in the third embodiment (the information-providing method achieved in the third embodiment) is explained in reference to a specific example. It is to be noted that FIG. 5, in reference to which the third embodiment is described above, may be regarded as a flowchart of the operation executed by the information-providing apparatus 300 in the third embodiment.

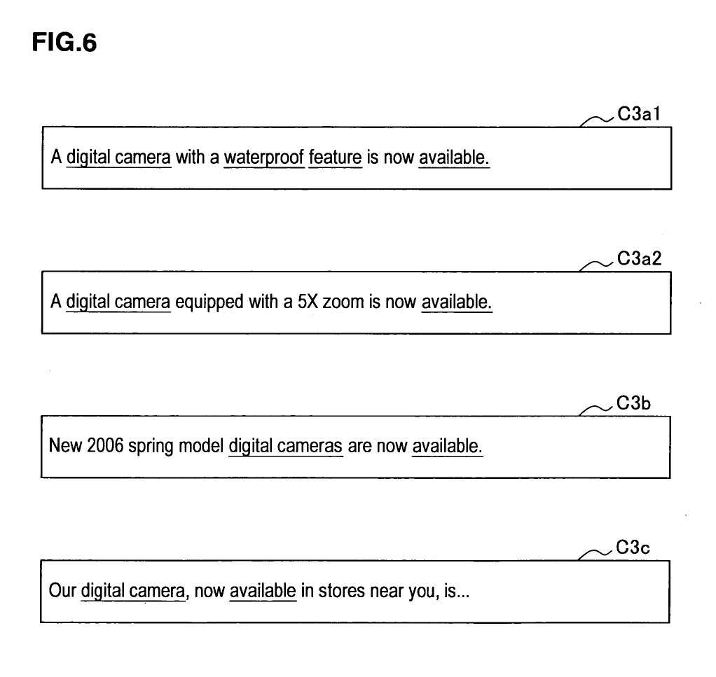

The information acquisition unit 311 obtains information satisfying specific conditions from an information source set in correspondence to each user at the user setting storage unit 321 and stores the obtained information at the delivery information storage unit 322. Let us now assume that delivery information (primary information) C3a1 in FIG. 6 is obtained from an information source 3a for a user 3A, that sets of delivery information C3a2, C3b and C3c in FIG. 6 are obtained for other users from information sources 3a, 3b and 3c respectively and that the sets of information thus obtained C3a1, C3a2, C3b and C3c are stored at the delivery information storage unit 322 with clear indications of the respective information sources 3a, 3b and 3c.

For the user 3A, the similarity factor calculation unit calculates similarity factors indicating the extents of the similarity between the delivery information C3a1 in FIG. 6 and the other sets of storage information C3a2, C3b and C3c in FIG. 6 stored in the delivery information storage unit 322. Although a detailed explanation is not provided, it is assumed that the similarity factor of the delivery information C3a1 and the storage information C3a2 is calculated to be 50%, that the similarity factor of the delivery information C3a1 and the storage information C3b is calculated to be 50% and that the similarity factor of the delivery information C3a1 and the storage information C3c is calculated to be 50% (refer to the first embodiment).

It is assumed that the information source 3b is pre-registered at the information source evaluation storage unit 323 as an excluded information source and information originating from the source is not to be provided as related information.

The information source evaluation unit 313 disqualifies the information source 3a, from which the delivery information C3a1 in FIG. 6 has been obtained for the subject user 3A, as a source of additional related information to be provided to the user. In addition, the information source evaluation unit 313 references the information at the information source evaluation storage unit 323 and judges the information source 3b registered at the information source evaluation storage unit 323 to be an excluded information source, the information from which is not to be selected as related information to be provided to the user 3A. An evaluation value corresponding to the number of users having set the information source 3c, which does not fulfill any of the conditions described above, as their information source is assigned to the information source 3c by the information source evaluation unit 313. For instance, the logarithmic value (total number of users/number of users having selected the information source) may be designated as the evaluation value. The following explanation is given by assuming that the information source 3c is assigned with a sufficiently high evaluation value, i.e., the information source 3c is judged to be highly suitable as a related information source.

The related information determining unit 314 makes a decision that either of the sets of storage information C3a2 and C3b in FIG. 6 originating from the information sources 3a and 3b having been disqualified by the information source evaluation unit 313 is not to be selected as related information, but determines that the storage information C3c in FIG. 6 is suitable as related information since the product of its similarity factor 50% and the evaluation value of the information source 3c provided by the information source evaluation unit 313 is sufficiently large.

The user 3A receives the storage information C3c in FIG. 6 as related information together with the delivery information C3a1 in FIG. 6 from the output unit 315.

As described above, when the information C3a1 from the information source 3a is delivered to the user 3A, the storage information C3a2 in FIG. 6 originating from the same information source 3a is not provided to the user 3A even if its similarity factor indicates a value in a desirable range.

While an explanation is given above on an example in which the information source evaluation unit 313 evaluates a storage information source to determine whether or not it is a desirable related information source from three different viewpoints (e.g., whether or not it is the information source from which the delivery information has originated, whether or not it is a well-known information source and whether or not it is an information source selected by numerous users), the evaluation may be executed from fewer viewpoints as long as the information source is evaluated based upon at least one viewpoint.

### (C-3) Advantages of the Third Embodiment

By adopting the third embodiment, it is ensured that information that the user is likely to read by accessing the information source from which the delivery information obtained for the user originates is not redundantly provided to the user.

In addition, as a familiar site such as a news site is registered at the information source evaluation storage unit as an excluded information source, information from which is not to be selected as related information, the information from such a well-known information source is not redundantly provided to the user. As a result, the user is not inundated with redundant information that he likely already has, such as information originating from a frequently visited site.

Other information sources are each evaluated to determine whether or not it is a widely known information source based upon the number of users having selected it as their information source, and the evaluation results are reflected when making a decision as to whether or not information originating from the particular information source is to be provided as related information.

As explained above, information originating from the information source from which the delivery information for a particular user has been obtained is not provided to the user. In addition, information originating from a widely known information source such as a news site is not redundantly provided to the user, since the user is likely to have access to the information already. Namely, by evaluating the individual information sources, it is ensured that users are not inundated with redundant information that they are likely to already have.

### (D) Fourth Embodiment

The following is a detailed explanation of the information-providing apparatus and the information-providing method achieved in the fourth embodiment of the present invention, given in reference to drawings.

### (D-1) Structure of the Fourth Embodiment

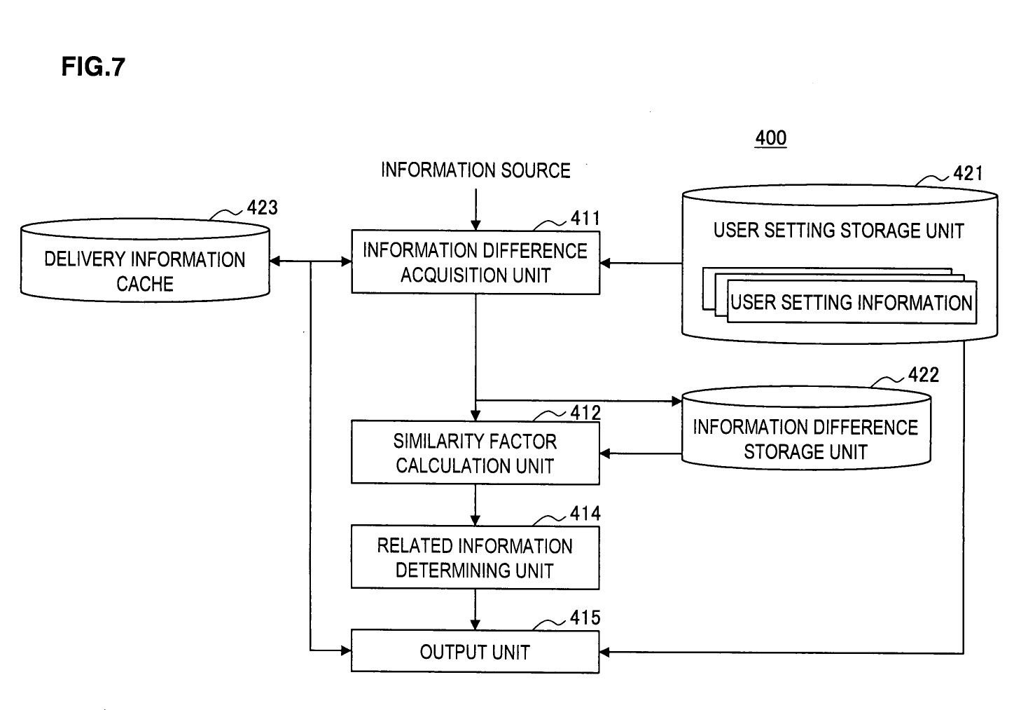

The information-providing apparatus in the fourth embodiment, too, is constituted by installing an information-providing program in an information processing apparatus with a communication function, such as a server or a personal computer, and adopts a functional structure such as that shown in FIG. 7. It is to be noted that in FIG. 7, corresponding reference numerals (with the numeral in the hundred place changed from “1” to “4”) are assigned to components identical to or corresponding to those in FIG. 1 in reference to which the first embodiment has been explained.

The information-providing apparatus 400 achieved in the fourth embodiment shown in FIG. 7 comprises a similarity factor calculation unit 412, a related information determining unit 414, an output unit 415 and a user setting storage unit 421 as does the information providing apparatus achieved in the first embodiment. The information-providing apparatus 400 further includes an information difference acquisition unit 411, an information difference storage unit 422 and a delivery information cache 423. It is to be noted that the fourth embodiment does not include a redundant information evaluation unit (113). The output unit 415 and the user setting storage unit 421 are similar to the output unit 115 and the user setting storage unit 121 in the first embodiment.

The information difference acquisition unit 411, which stores in the information cache 423 the past delivery information including the most recent delivery information, originating from the information sources set in correspondence to all the users in the user setting storage unit 421, outputs only the part of the delivery information obtained through the current operation for each user, that is different from the most recent delivery information. The output portion of the delivery information corresponding to the difference is then stored into the information difference storage unit 422. The difference is defined in units of specific information blocks, e.g., in units of lines, sentences or paragraphs. The information difference constituting the portion of the delivery information different from the previous delivery information may be obtained by a adopting any of various existing difference acquisition methods as long as information difference with new content is obtained by comparing the current delivery information with the previous delivery information and by eliminating only the completely identical content to define the information difference or by eliminating lines and the like achieving a specific level of similarity to define the information difference.

The content of the information cache 423, in which the delivery information having been obtained in the past including the most recent delivery information is stored, are updated with the newest set of delivery information each time the information difference acquisition unit 411 obtains information and outputs new information difference.

At the information difference storage unit 422, the information difference obtained by the information difference acquisition unit 411 is stored as storage information over a predetermined limited length of time. For instance, it may hold only the current information difference, or the immediately preceding information difference as the storage information.

For each user, the similarity factor calculation unit 412 calculates similarity factors indicating the extents of similarity between the individual sets of storage information stored at the information difference storage unit 422 and the information difference obtained in correspondence to the user at the information difference acquisition unit 411. While the similarity factors between the individual information differences are calculated in this example, similarity factors indicating the extents of similarity between the delivery information itself originating from a specific information source in correspondence to a given user and the individual sets of storage information at the information difference storage unit 422 may be calculated instead. In either case, the similarity factors can be calculated by adopting a standard similar document search method.

The related information determining unit 414 detects related information to be provided to the specific user together with delivery information having been obtained for the user among the individual sets of storage information, based upon the similarity factors provided by the similarity factor calculation unit 412. For instance, a predetermined number of sets of storage information with the highest similarity factors may be selected as the related information.

### (D-2) Operation executed in the Fourth Embodiment

Next, the operation executed by the information-providing apparatus 400 in the fourth embodiment (the information-providing method achieved in the fourth embodiment) is explained in reference to a specific example. It is to be noted that FIG. 7, in reference to which the fourth embodiment is described above, may be regarded as a flowchart of the operation executed by the information-providing apparatus 400 in the fourth embodiment.

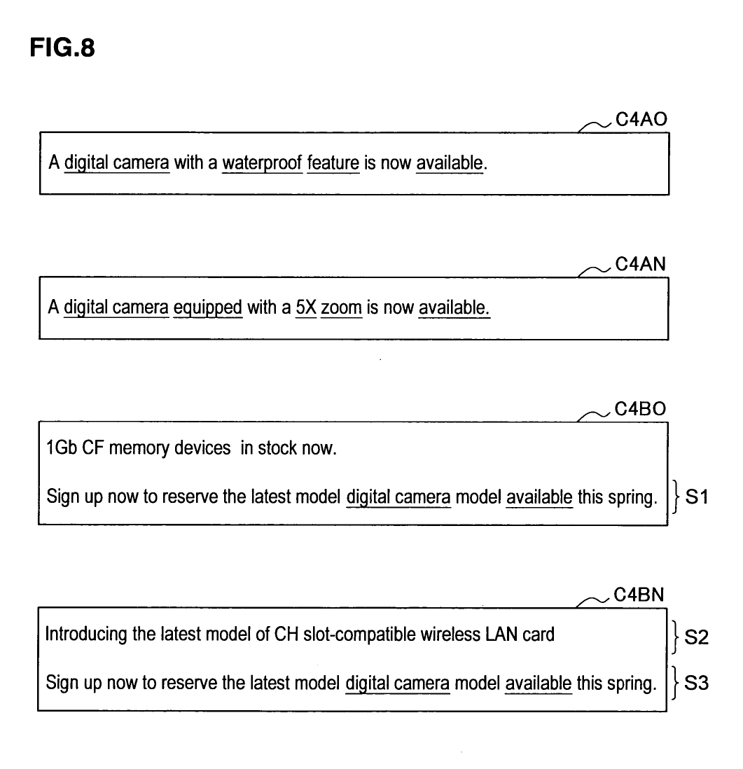

The information difference acquisition unit 411 obtains information satisfying specific conditions from information sources set in correspondence to the individual users at the user setting storage unit 421. It is assumed that delivery information C4AO in FIG. 8 is obtained from an information source 4a set in correspondence to a user 4A and that delivery information C4BO in FIG. 8 is obtained from an information source 4b set in correspondence to another user 4B. If sets of information identical to C4AO and C4BO have not been obtained from the information sources 4a and 4b respectively, all the sets of delivery information are stored at the delivery information cache 423 as the differences from the most recent delivery information, and each set of current delivery information is stored into the information difference storage unit 422 in its entirety. In addition, the sets of delivery information C4AO and C4BO having been obtained are stored into the delivery information cache 423.

For the user 4A, the similarity factor calculation unit 412 calculates similarity factors indicating the extents of similarity between the delivery information C4AO in FIG. 8 having been obtained for the user 4A and the storage information C4BO in FIG. 8 at the information difference storage unit 422 obtained not for the user 4A but for the user 4B.

From the delivery information C4AO in FIG. 8, words such as “digital camera”, “waterproof”, “feature” and “available” can be extracted as keywords through standard natural language processing technology such as morphological analysis. The storage information C4BO in FIG. 8 contains two of the four keywords in its portion S1 and, accordingly, its similarity factor is calculated to be 2/4=50%. (While the similarity factor is calculated as the ratio of the number of keywords contained in the target storage information to simplify the explanation, the similarity factor may be calculated in conjunction with a standard document search evaluation methods by, for instance, adjusting the weight of each keyword through an idf adjustment.) The related information determining unit 414 in the embodiment judges the similarity factor of 50% calculated to indicate the extent of similarity manifested by the storage information C4BO relative to the delivery information C4AO in FIG. 8 to be high enough and thus selects the storage information C4BO as related information.

The user 4A receives the information C4BO in FIG. 8 as related information together with the delivery information C4AO in FIG. 8 from the output unit 415.

Let us now assume that the information difference acquisition unit 411 next obtains delivery information C4AN in FIG. 8 from the information source 4a selected by the user 4A and obtains delivery information C4BN in FIG. 8 from the information source 4b selected by the other user 4B. The delivery information C4AN in FIG. 8 is compared with the delivery information C4AO in FIG. 8, which has been previously obtained from the same information source 4a and stored in the delivery information cache 423, in units of sentences. Since the current delivery information does not match the previous delivery information, an information difference constituted with the entire delivery information C4AN is obtained. The delivery information C4BN in FIG. 8 is compared with the delivery information C4BO in FIG. 8, which has been previously obtained from the same information source 4b and stored in the delivery information cache 423, in units of sentences. Since the sentence S3 in the information C4BN in FIG. 8 matches the sentence S 1 in the information C4BO in FIG. 8, an information difference constituted with the sentence S2 in the information C4BN in FIG. 8 minus the matching sentence, is obtained.

The information C4AN in FIG. 8 and the sentence S2 in the information C4BN in FIG. 8 are thus stored as information differences at the information difference storage unit 422.

In addition, the delivery information C4AN and the delivery information C4BN in FIG. 8 are stored into the delivery information cache 423.

For the user 4A, the similarity factor calculation unit 412 calculates a similarity factor indicating the extent of the similarity between the delivery information C4AN in FIG. 8 delivered to the user 4A and the sentence S2 in the information C4BN in FIG. 8 stored in the information difference storage unit 422 in correspondence to the other user 4B.

From the delivery information C4AN in FIG. 8, words such as “digital camera”, “equipped with”, “5×”, “zoom” and “available” can be extracted as keywords through a standard natural language processing technology such as morphological analysis. The similarity factor of the delivery information C4AN and the sentence S2 stored in the information difference storage unit 422, which does not contain any of these five keywords, is calculated to be 0%.

Since the similarity factor calculated in correspondence to the sentence S2 in the information C4BN in FIG. 8 stored at the information difference storage unit 422 is very low at 0%, the related information determining unit 414 does not judge the sentence S2 to be information related to the delivery information C4AN.

While the user 4A receives the delivery information C4AN in FIG. 8, the information C4BN intended for the user 4B in FIG. 8 is not provided to the user 4A via the output unit 415.

As described above, the user 4A, having received the information C4AO in FIG. 8, is also provided with the information C4BO in FIG. 8 initially delivered to the user 4B. However, as he subsequently receives the information C4AN in FIG. 8, the portion S3 of the information C4BN in FIG. 8 delivered to the user 4B, which is identical to a portion of the information C4BO in FIG. 8 having been already provided to the user 4A, is handled as excluded information and thus is not provided to the user 4A in duplicate.

In the method in the related art, the matching keywords “available” and “digital camera” in the information portion S3 in FIG. 8 will raise the similarity factor and thus, the delivery information C4BN containing a sentence identical to the portion S1 in the information C4BO in FIG. 8 having already been provided to the user 4A will be provided to the user 4A yet again. By adopting the fourth embodiment, however, it is ensured that the user is not provided with the same information in duplicate.

### (D-3) Advantages of the Fourth Embodiment

In the fourth embodiment, the current delivery information obtained for a given user is compared with the previous delivery information and only the portion of the current delivery information that is different from the content of the previous delivery information is saved. Thus, identical information content that repeatedly appear in different sets of the delivery information are only stored into the information difference storage unit when they are first detected. As a result, even when the overall similarity factor indicates a high value due to the presence of such identical information content, a similarity factor with a smaller value can be calculated by using the information difference constituted with the portion of the current delivery information minus the identical content. This means that the current delivery information with the identical content is not provided as related information. In other words, the user is assured that only the information new to him is provided.

### (E) Other Embodiments

The explanation has been given in reference to the individual embodiments by assuming that information having been delivered to another user is provided as related information to the subject user based upon the delivery information obtained for the subject user in a system in which information is delivered to a plurality of users. However, the first or fourth embodiment may be adopted when providing information other than that delivered to another user as the related information. In addition, the third embodiment may be adopted to provide related information constituted with information other than that delivered to another user if the information source evaluation does not need to be executed based upon the details of the information source settings selected by the individual users.

In addition, the delivery information may be received in the form of, for instance, an e-mail magazine transmitted to the user, a Web document or it may be database information to which the user regularly subscribes.

While an explanation is given above in reference to the individual embodiments on an example in which delivery information having been delivered to other users is evaluated as related information candidates to determine whether or not the delivery information should be provided to another user as related information, only a single related information candidate may be stored (in the cache as well) even when there are a plurality of users to whom delivery information has been delivered.

In addition, the technical teachings of the first through fourth embodiments may be adopted in combination. For instance, by adopting the technical teachings of the first, third and fourth embodiments in combination, it is possible to ensure that the user is not presented with information with a high similarity factor containing substantially identical content, information originating from a commonly accessed information source and thus not likely to be desired new information or information indicated by the latest information difference to contain identical content to that of the information provided in the past.

While the second embodiment adds a limitation to the technical teachings of the first embodiment in that the related information is constituted with information having been delivered to a similar user, the limitation introduced in the second embodiment that the related information is constituted with information having been delivered to a similar user may also be applied in conjunction with the technical teaching of the third or fourth embodiment.

Moreover, delivery information having been delivered to other users in the past (information delivered within a predetermined period of time in the past or a predetermined number of sets of past delivery information), instead of the delivery information most recently received by other users, may be designated as related information candidates. The same concept may be adopted in the fourth embodiment in which the difference from the previous information is evaluated. In other words, the concept may be adopted in the fourth embodiment so as to examine the difference between a preceding set of delivery information and a succeeding set of delivery information with regard to the delivery order.

What is claimed is;

1. An information-providing apparatus for obtaining delivery information to be delivered to a user from an information source and delivering the delivery information to the user based upon a setting selected by the user and providing related information related to the delivery information, the information-providing apparatus comprising:
an overlapping information averting unit for selecting the related information by disqualifying a related information candidate that would overlap the delivery information or would be likely to overlap the delivery information among related information candidates being considered to be used as the related information.

2. An information-providing apparatus according to claim 1, wherein:
the overlapping information averting unit includes;
a similarity factor calculation unit that calculates similarity factors each indicating the extent of similarity between the delivery information delivered to the user and one of the related information candidates;
a redundant information evaluation unit that evaluates the related information candidates and determines that a related information candidate with a higher similarity factor, having been calculated by the similarity factor calculation unit, has a higher redundancy level indicating that the related information candidate does not need to be provided to the user; and
a related information determining unit that something the related information from related information candidates with redundancy levels determined by the redundant information evaluation unit equal to or less than a redundancy threshold value and similarity factors calculated by the similarity factor calculation unit equal to or greater than a similarity factor threshold value.

3. An information-providing apparatus according to claim 1, wherein:
the overlapping information averting unit includes;
a similarity factor calculation unit that calculates similarity factors each indicating the extent of similarity between the delivery information delivered to the user and one of the related information candidates;
an information source evaluation unit that assigns an information source evaluation value indicating the suitability thereof as a related information to the information source of each of the related information candidates; and
a related information determining unit that selects the related information from related information candidates originating from information sources with information source evaluation values designated by the information source evaluation unit higher than an information source threshold value and similarity factors calculated by the similarity factor calculation unit equal to or greater than a similarity factor threshold value.

4. An information-providing apparatus according to claim 3, wherein:
the information source evaluation unit designates a low information source evaluation value to the information source from which the delivery information for the user has originated.

5. An information-providing apparatus according to claim 3, wherein:
the overlapping information averting unit further includes:
an information source evaluation storage unit at which an information source to be designated with a low information source evaluation value is registered; and
the information source evaluation unit sets a low information source evaluation value for the information source registered at the information source evaluation storage unit.

6. An information-providing apparatus according to claim 3, wherein:
the information source evaluation unit sets a lower information source evaluation value for an information source selected as an information source by a greater number of users.

7. An information-providing apparatus according to claim 1, wherein:
the overlapping information averting unit includes;
a delivery information cache in which most recent delivery information for the user and related information candidates are stored;
an information difference acquisition unit that obtains an information difference representing a portion of delivery information for the user that is different from the content of the previously obtained information stored in the delivery information cache and obtains information differences each representing a portion of a related information candidate that is different from the content of the previously obtained information stored in the delivery information cache;
a similarity factor calculation unit that calculates similarity factors each indicating the extent of similarity between the delivery information or the information difference corresponding to the user and the information difference corresponding to one of the related information candidates; and
a related information determining unit that selects the related information from related information candidates with similarity factors calculated by the similarity factor calculation unit equal to or greater than a similarity factor threshold value.

8. An information-providing apparatus according to claim 1, wherein:
the overlapping information averting unit designates delivery information obtained for a user other than the user as a related information candidate.

9. An information-providing apparatus according to claim 8, wherein:
the overlapping information averting unit includes a storage unit in which past delivery information having been delivered to users other than the user within a predetermined length of time or a predetermined number of sets of past delivery information having been delivered to users other than the user are stored as related information candidates.

10. An information-providing apparatus according to claim 8, wherein:
the overlapping information averting unit includes:
a similar user judging unit that detects a similar user having been provided with information similar to the information having been provided to the user; and
selects the related information from sets of delivery information having been delivered to the similar user.

11. An information-providing method for obtaining delivery information to be delivered to a user from an information source and delivering the delivery information to the user based upon a setting selected by the user and providing related information related to the delivery information, the information-providing method comprising:
an overlapping information averting step in which the related information is selected by disqualifying a related information candidate that would overlap the delivery information or would be likely to overlap the delivery information among related information candidates being considered to be used as the related information.

12. An information-providing method according to claim 11, wherein:
the overlapping information averting step includes:
a similarity factor calculation sub-step in which similarity factors, each indicating the extent of similarity between the delivery information delivered to the user and one of the related information candidates, are calculated;
a redundant information evaluation sub-step in which each of the related information candidates is evaluated and a related information candidate with a higher similarity factor, having been calculated through the similarity factor calculation sub-step, is determined to have a high redundancy level indicating that the related information candidate does not need to be provided to the user; and
a related information determining sub-step in which the related information is selected from related information candidates with redundancy levels determined through the redundant information evaluation sub-step equal to or lower than a redundancy threshold value and similarity factors calculated through said similarity factor calculation sub-step equal to or greater than a similarity factor threshold value.

13. An information-providing method according to claim 11, wherein:
the overlapping information averting step includes:
a similarity factor calculation sub-step in which similarity factors, each indicating the extent of similarity between the delivery information delivered to the user and one of the related information candidates, are calculated;
an information source evaluation sub-step in which an information source evaluation value indicating the suitability as a related information is designated to the information source of each related information candidate; and
a related information determining sub-step in which the related information is selected from related information candidates originating from information sources with information source evaluation values designated thereto through the information source evaluation sub-step greater than an information source threshold value and similarity factors calculated through the similarity factor calculation sub-step equal to or greater than a similarity factor threshold value.

14. An information-providing method according to claim 13, wherein:
in the information source evaluation sub-step, a lower information source evaluation value is designated to the information source from which said delivery information for the user has originated.

15. An information-providing method according to claim 13, wherein:
in the information source evaluation sub-step, a low information source evaluation value is set for an information source registered at an information source evaluation storage unit at which an information source to be designated with a low information source evaluation value is registered.

16. An information-providing method according to claim 13, wherein:
in the information source evaluation sub-step, a lower information source evaluation value is designated to an information source selected as an information source by a greater number of users.

17. An information-providing method according to claim 11, wherein:
the overlapping information averting step includes:
an information difference acquisition sub-step, in which an information difference representing a portion -of delivery information obtained for the user that is different from the content of previously obtained information stored in a delivery information cache where most recent delivery information for the user and related information candidates corresponding to the user are stored is obtained and information differences each representing a portion of each related information candidate that is different from the content of previously obtained information stored in the delivery information cache, are obtained;
a similarity factor calculation sub-step in which similarity factors each indicating the extent of similarity between the delivery information or the information difference corresponding to the user and the information difference corresponding to one of the related information candidates are calculated; and
a related information determining sub-step in which the related information is selected from related information candidates with similarity factors calculated through the similarity factor calculation sub-step equal to or greater than a similarity factor threshold value.

18. An information-providing method according to claim 11, wherein:
in the overlapping information averting step, delivery information having been obtained for a user other than the user is designated as a related information candidate.

19. An information-providing method according to claim 18, wherein:
the overlapping information averting step includes;
a storage sub-step in which past delivery information having been delivered to users other than the user within a predetermined length of time or a predetermined number of sets of past delivery information having been delivered to users other than the user are stored or cached as related information candidates.

20. An information-providing method according to claim 18, wherein:
the overlapping information averting step, includes;
a similar user judging sub-step in which a similar user having been provided with information similar to the information having been provided to the user is detected; and
in the overlapping information averting step, the related information is selected from sets of delivery information having been delivered to the similar user.
